(19) United States
(12) Patent Application Publication
(10) Pub. No.: US 2023/0105561 A1
(43) Pub. Date: Apr. 6, 2023

(54) INSULATING PACKAGING FOR CRUSTACEANS

(71) Applicant: Planet Protector Packaging Pty Limited, Yennora (AU)

(72) Inventor: Patrick James O'Flynn, Yennora (AU)

(21) Appl. No.: 17/797,893

(22) PCT Filed: Feb. 4, 2021
(86) PCT No.: PCT/AU2021/050084

§ 371 Date: Aug. 5, 2022

(30) Foreign Application Priority Data
Feb. 6, 2020 (AU) 2020900324

(51) Int. Cl. A01K 63/02; B65D 81/26; B65D 81/38; B65D 77/04

(52) U.S. Cl. CPC A01K 63/02; B65D 81/264; B65D 81/3834; B65D 77/042

(57) ABSTRACT

A thermally insulated package having an outer container formed of fiberboard and comprising a base wall, a peripheral side wall and a closable top wall. The base wall, side wall and top wall defining a container interior. An insert is fitted within the container interior and formed of fiberboard. The insert comprising a floor panel and a peripheral side panel defining an insulated compartment and open top. The floor panel and side panel are each associated with the base wall and side wall of the container respectively. A thermal insulating layer to be interposed between the outer container and the insert, said insulating layer including wool fibers.

### FIELD

The invention relates to packaging, and in particular, insulated containers. The invention has been developed as a container for live crustaceans including lobsters, crayfish, crabs and the like however is not limited to this particular use.

### BACKGROUND

Crustaceans including, lobsters, crayfish and crabs have unforgiving packaging requirements given they are highly valuable, perishable, are sensitive to temperature and cannot be crushed. These sensitivities are exacerbated because crustaceans are normally sold and/or shipped live to preserve freshness but also because it is more difficult to control temperature and other transport parameters to which the carton is subjected. While dedicated packaging has been developed for this use, it has significant shortcomings. For instance, U.S. Pat. No. 6,041,931 describes a lidded container for lobsters or crustaceans which includes wells to receive and retain ice which, as they melt are directed to circulate about the lobsters. However, the container does not offer any thermal insulation and is only intended for use over shorter distances before the ice melts. In addition, it is often not feasible to have packaging leaking fluids, such as water.

The industry standard for thermally insulated packaging is currently expanded polystyrene (EPS) based thermal packaging. This packaging is commonly used in the transportation of hot and cold foods, pharmaceuticals and temperature sensitive goods including seafood and live crustaceans. However, EPS based packaging has significant drawbacks, including being non-biodegradable and having low strength which provides poor volumetric efficiency. Furthermore, it is not uncommon for live crustaceans to excrete liquid and solid waste which cannot be absorbed by EPS packaging.

To date, no environmentally responsible packaging for transporting live crustaceans has been developed that addresses the significant shortcomings of current packaging.

It is the object of the present invention to substantially overcome, or at least ameliorate, one or more of the disadvantages of the prior art, or to at least provide a useful alternative.

### SUMMARY OF INVENTION

According to one aspect of the invention as presently contemplated there is provided a thermally insulated package having:

an outer container formed of fiberboard and comprising a base wall, a peripheral side wall and a closable top wall, said base wall, side wall and top wall defining a container interior;

an insert to be fitted within the container interior and formed of fiberboard, said insert comprising a floor panel and a peripheral side panel defining an insulated compartment and open top, wherein said floor panel and side panel are each associated with the base wall and side wall of the container respectively; and

a thermal insulating layer to be interposed between the outer container and the insert, said insulating layer including wool fibers.

Preferably the corrugated fiberboard material is capable of being recycled or is substantially biodegradable or compostable or any combination thereof.

Preferably the outer container walls include a water-resistant coating or treatment to provide water resistance for packing in wet environments. Preferably the water-resistant coating or treatment is biodegradable and non-toxic. The water-resistant coating or treatment does not interfere with the biodegradability or recyclability of the corrugated carton.

Preferably the outer container is constructed from a single piece blank. More preferably the outer container is constructed from cut, scored and folded corrugated fiberboard material.

Preferably the container side wall includes a pair of opposite side sections and a pair of opposite end sections.

Preferably the base wall is formed from at least one base flap connected to a lower edge of the side wall. Preferably the base wall is formed of a plurality of base flaps each base flap connected to a respective lower edge of an associated side/end section.

Preferably the top wall is formed from at least one top flap connected to an upper edge of the side wall. Preferably the top wall is formed of a plurality of top flaps each top flap connected to a respective upper edge of an associated side/end section.

Preferably the outer container is formed as a regular slotted container (RSC). Alternatively, the container is an overlap slotted container (OSC), full overlap slotted container (FOL); center special slotted container; center special overlap slotted container; center special full overlap slotted container.

Preferably the thermal insulating layer includes one or more sorbent materials for absorbing and/or adsorbing fluid. Preferably the insulating layer includes one or more hydrophilic and/or oleophilic materials. Preferably, the thermal insulating layer includes a complex wool fibre composite.

Preferably the thermal insulating layer is capable of being recycled or is substantially biodegradable or compostable or any combination thereof.

Preferably the insulating layer is interposed between the base wall of the container and the floor of the insert and between the peripheral side wall of the container and the peripheral side of the insert.

Preferably the bottom panel includes at least one drainage aperture to allow liquid to drain from the insulated compartment. More preferably the bottom panel has a drainage aperture disposed at or adjacent a respective corner. Most preferably the bottom panel has four drainage apertures.

Preferably the insert is capable of being recycled or is substantially biodegradable or compostable or any combination thereof.

Preferably the insert is formed as a floor panel and a plurality of peripheral side panels connected thereto. Preferably the package includes a lid panel associated with container top wall, said lid panel fitted within the container interior and formed of recyclable and/or biodegradable fiberboard.

In alternative aspect the outer container and/or insert are formed from paperboard, polymer, polyethylene, polylactic acid, silica, starch-based polymers, cellulose-based polymer, liquid paperboard or wood.

Preferably, the container is adapted to for the transport of crustaceans and in particular live crustaceans including crabs, lobsters, crayfish, sea urchins.

According to another aspect of the invention as presently contemplated there is provided a method of assembling a thermally insulated package comprising the steps of:

forming an outer fiberboard container comprising a base wall, a peripheral side wall and a closable top wall, said base wall, side wall and top wall defining a container interior;

inserting into the container interior an insulating liner assembly comprising:
a fiberboard insert, comprising a floor panel and a peripheral side panel defining an insulated compartment and open top, wherein said floor panel and side panel are each associated with the base wall and side wall of the container respectively; and
a thermal insulating layer interposed between the outer container and the insert, said insulating layer including wool fibers.

Preferably at least a portion of the insulating layer is inserted into the container interior to line the base wall and peripheral side wall before the insert is inserted. Alternatively, the insulating liner assembly comprising the fiberboard insert and the thermal insulating layer are assembled and inserted into the container interior simultaneously.

### BRIEF DESCRIPTION OF DRAWINGS

Preferred embodiments of the present invention will now be described, by way of examples only, with reference to the accompanying drawings, in which:

FIG. 1 is a schematic perspective view of thermally insulating packaging in accordance with the invention;

FIG. 2 is an exploded schematic perspective view of the thermally insulating packaging shown in FIG. 1; and

FIGS. 3A and 3B are plane and perspective views of an insert for thermally insulating packaging laminate of Figure.

### DETAILED DESCRIPTION OF EMBODIMENTS

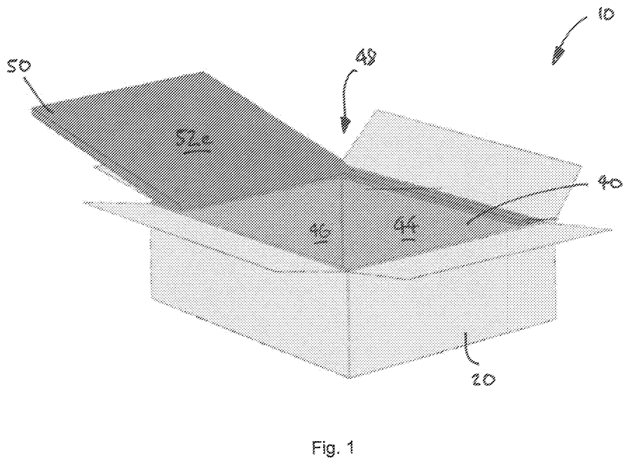

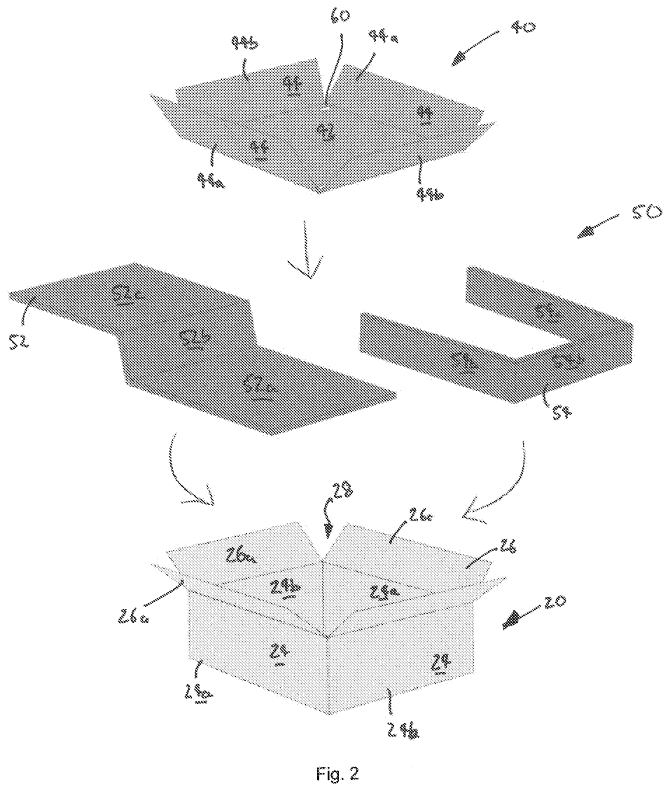

FIG. 1 shows a perspective view of a thermally insulated package 10. The package includes an outer container 20, and as is best seen with reference to FIG. 2, comprising a base wall 22, a peripheral side wall 24 and a closable top wall 26. The base wall 22, side wall 24 and top wall 26 define a container interior 28.

While the outer container 20 may take a variety of shapes, for instance, feasibly the container may have any number of straight or curved side walls, typically, and as shown in the figures, the container is a rectangular box such that the side wall 24 includes a pair of opposite side panels 24a and a pair of opposite end panels 24b.

In this embodiment, the outer container 20 is constructed from one or more cut, scored and folded corrugated fiberboard blanks. While fiberboard may be used, corrugated fiberboard is preferred since it typically imparts greater stiffness to the container walls and corresponding structural integrity to the container thereby allowing stacking and the like whilst protecting the contents within.

The method of constructing containers from cardboard blanks is well known in the art and many different variations on this method may be applied to the invention. For instance, the figures depict a regular slotted container (RSC) wherein the base wall is formed from a plurality of base flaps each base flap connected to a respective lower edge of an associated side/end panel. An opposing pair of base flaps are each one-half the container's width so they can meet in the center and be joined by tape, or staples to close the base of the container. Similarly, the top wall is formed of a plurality of top flaps 26a, each top flap connected to a respective upper edge of an associated side/end panel. However, other types of box construction may be used including but not limited to overlap slotted containers (OSC), full overlap slotted containers (FOL); center special slotted containers; center special overlap slotted containers and center special full overlap slotted containers.

Referring to the Figures, an insert 40 is fitted within the container interior 28 and is formed of recyclable fiberboard. The insert 40 comprises a floor panel 42 and a peripheral side 44 defining an insulated compartment 46 and opening 48. The peripheral side 44 includes a pair of opposite side panels 44a and a pair of opposite end panels 44b. The floor panel 42 and side 44 are associated with the base wall 22 and side wall of the container respectively and sized accordingly.

The insert 40 further includes a lid panel (not shown) which is associated with the top wall 22 and may be used to close the opening 48.

In this embodiment the floor panel 42 and peripheral side panels 44a, 44b are formed from a single cardboard blank and the lid panel is separate. Each side panel being attached to a respective peripheral edge of the rectangular floor panel 42. Preferably the blank is scored along each peripheral edge of the floor panel 42 to provide predisposed fold lines to assist assembly of the insert and insertion into the container interior during assembly of the thermally insulated package. In some embodiments however the lid panel may be attached to one of the sides or the lid may comprise a number of separate flap panels each attached to a respective side panel.

The outer container is a preferably a corrugated fiberboard and the insert is a fiberboard. However, each are capable of recycling or are substantially biodegradable, compostable or any combination thereof. Furthermore, both the container and insert include a coating or treatment to provide water resistance and/or water repellant qualities. Water-resistant/repellant coatings and treatments may comprise an acrylic copolymer. For example water-based printing ink & coatings such as Esteprint Waterborne Ink which comprises:

| | CAS RN | % |
|---|---|---|
| Ethanolamine | 141-43-5 | <1% |
| Acrylic Copolymer | Proprietary | 35-55% |
| Acrylic Monomers | Proprietary | 0-02% |
| Cyclic Halogenated Biocide | Proprietary | 0-01% |
| Isopropyl Alcohol | 67-63-0 | <3% |

P0016621PCT In this embodiment the coating or treatment is food-safe, non-toxic and/or biodegradable.

Interposed between the outer container and the insert a thermal insulating layer 50 including wool fibers, which provide the container with thermally insulative properties. As can be seen with reference to FIG. 2, the insulating layer substantially surrounds the entire compartment 46 include top bottom and all sides. Preferably, in addition to insulation, the wool fibre composite also provides a degree of cushioning to cargo in the container and, as will be seen, hygroscopic properties to soak up fluids and moisture in the container.

With reference to FIG. 2, the thermal insulating layer 50 may include multiple pieces of insulative sheet material. In this embodiment a first sheet 52 includes first, second and third portions (52a, 52b, & 52c respectively). The first portion 52a is sized and shaped to cover the base wall of the container, the second portion 52b, covers one of the side walls of the container while the third portion 52c covers the top wall. The second sheet 54 also includes first, second and third portions (54a, 54b, & 54c respectively) each for covering a respective side wall of the container. In some embodiments the insulating layer may be preconstructed so that portions 52a, 52b, 54a, 54b and 54c are conjoined at respective peripheral edges to form a container shaped soft walled bag for convenient assembly of the package.

The thermal insulating sheet material may include a wool fiber composite comprising a blend of wool and other natural fibers. The wool and natural fibers improve hygroscopic and thermal insulative properties while remaining compostable. Advantageously the wool blend also retains insulative properties when wet. The wool used is scoured, felted compressed and cut to size. Fibrous strands are aligned by felting and the following compression holds the composite's compressed state. This allows the material to be easily cut to size. Wool fiber composite is only one example of an insulating natural fibers layer.

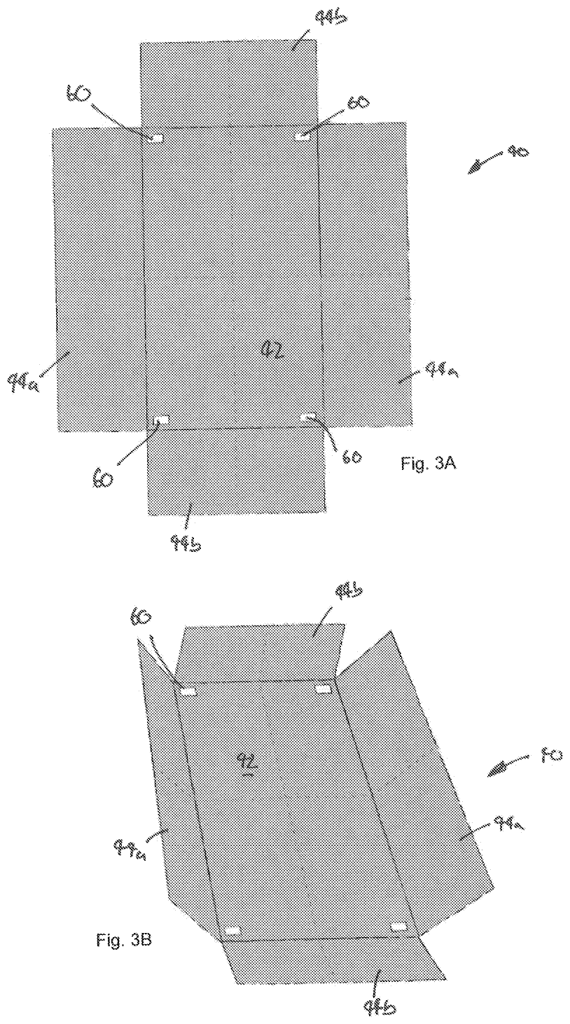

Referring to FIGS. 3A and 3B, the bottom panel of the insert includes at least one drainage aperture 60, to allow liquid to drain from the insulated compartment and be absorbed of adsorbed in the insulative layer. In this embodiment, four drainage apertures 60 are provided, one in each corner which reduces the likelihood of fluid accumulating in a corner of the liner should the container not be level.

To assemble the thermally insulated package, first the outer container is constructed by unfolding the blank and securing the base wall, as required, for instance with an adhesive or tape. Then the first sheet 52 of the insulating layer is laid in the container interior with the first portion 52a overlaying the container base, the second portion 52b, covering one of the container sides 24b and the third portion 52c hanging out of the container. Next the second sheet 54 is inserted into the container so that each of the portions 54a, 54b and 54c cover an inner face of a respective one of remaining container side walls of the container. Finally, the insert 40 is folded so that the side panels are each perpendicular to the floor panel and the insert is inserted to line the container thereby forming the internal floor and side walls of the insulated container which may be filled with product (for instance live crustaceans including crabs, lobsters, crayfish and the like). The lid can be placed over the top of the compartment and the third portion 52c of the insulating layer 52 wrapped over the top of the lid before the container flaps 26a are closed and secured with adhesive or tape.

In the case where the insulating layer is preconstructed to form a container shaped soft walled bag, it may be more convenient to insert the insert into the bag to line the bag and provide it with some stiffness before inserting the bag/insert assembly into the preconstructed outer container.

Preferably, the container is adapted to for the transport of crustaceans and in particular live crustaceans including crabs, lobsters, crayfish or the like.

It will be appreciated that the invention provides an insulated container which is able to retain an amount of liquid internally, both due to the sorbing qualities of the insulating layer and the water resistance of the outer container. The liquid is allowed to drain from the insulated compartment and held in an insulating layer displaced from the compartment contents.

1. A thermally insulated package having:
an outer container formed of fiberboard and comprising a base wall, a peripheral side wall and a closable top wall, said base wall, side wall and top wall defining a container interior;
an insert to be fitted within the container interior and formed of fiberboard, said insert comprising a floor panel and a peripheral side panel defining an insulated compartment and open top, wherein said floor panel and side panel are each associated with the base wall and side wall of the container respectively; and
a thermal insulating layer to be interposed between the outer container and the insert, said insulating layer including wool fibers.

2. The thermally insulated package of claim 1, wherein the corrugated fiberboard material is capable of being recycled or is substantially biodegradable or compostable or any combination thereof.

3. The thermally insulated package of claim 1, wherein the outer container walls include a water-resistant coating or treatment to provide water resistance for packing in wet environments.

4. The thermally insulated package of claim 1, wherein the outer container is constructed from a single piece blank.

5. The thermally insulated package of claim 1, wherein the container side wall includes a pair of opposite side sections and a pair of opposite end sections.

6. The thermally insulated package of claim 1, wherein the base wall is formed from at least one base flap connected to a lower edge of the side wall.

7. The thermally insulated package of claim 1, wherein the top wall is formed from at least one top flap connected to an upper edge of the side wall.

8. The thermally insulated package of claim 1, wherein the outer container is formed as a regular slotted container (RSC).

9. The thermally insulated package of claim 1, wherein the thermal insulating layer includes one or more sorbent materials for absorbing and/or adsorbing fluid.

10. The thermally insulated package of claim 1, wherein the thermal insulating layer is capable of being recycled or is substantially biodegradable or compostable or any combination thereof.

11. The thermally insulated package of claim 1, wherein the insulating layer is interposed between the base wall of the container and the floor of the insert and between the peripheral sidewall of the container and the peripheral side of the insert.

12. The thermally insulated package of claim 1, wherein the bottom panel includes at least one drainage aperture to allow liquid to drain from the insulated compartment.

13. The thermally insulated package of claim 1, wherein the insert is capable of being recycled or is substantially biodegradable or compostable or any combination thereof.

14. The thermally insulated package of claim 1, wherein the insert is formed as a floor panel and a plurality of peripheral side panels connected thereto.

15. The thermally insulated package of claim 1, wherein the outer container and/or insert are formed from paperboard polymer, polyethylene, polylactic acid, silica, starch-based polymers, cellulose-based polymer, liquid paperboard or wood.

16. The thermally insulated package of claim 1, wherein the container is adapted to for the transport of crustaceans and in particular live crustaceans including crabs, lobsters and crayfish.

17. A method of assembling a thermally insulated package comprising the steps of:
forming an outer fiberboard container comprising a base wall, a peripheral side wall and a closable top wall, said base wall, side wall and top wall defining a container interior;
inserting into the container interior an insulating liner assembly comprising:
a fiberboard insert, comprising a floor panel and a peripheral side panel defining an insulated compartment and open top, wherein said floor panel and side panel are each associated with the base wall and side wall of the container respectively; and
a thermal insulating layer interposed between the outer container and the insert, said insulating layer including wool fibers.

18. The method according to claim 17, whereby at least a portion of the insulating layer is inserted into the container interior to line the base wall and peripheral side wall before the insert is inserted.

19. The method according to claim 18, whereby; the insulating liner assembly comprising the fiberboard insert and the thermal insulating layer are assembled and inserted into the container interior simultaneously.
